(19) United States
(12) Patent Application Publication
(10) Pub. No.: US 2014/0090972 A1
(43) Pub. Date: Apr. 3, 2014

(54) DIRECT PHOTOCONVERSION OF CARBON DIOXIDE TO LIQUID PRODUCTS

(71) Applicant: ANTECY B.V., HOEVELAKEN (NL)

(72) Inventors: Paul O'CONNOR, HOEVELAKEN (NL); Avelino CORMA CANOS, VALENCIA (ES); Hermenegildo GARCIA GOMEZ, VALENCIA (ES)

(73) Assignee: ANTECY B.V., HOEVELAKEN (NL)

(21) Appl. No.: 14/100,033

(22) Filed: Dec. 9, 2013

Related U.S. Application Data
(63) Continuation of application No. PCT/EP2012/060790, filed on Jun. 7, 2012.

(51) Int. Cl. B01J 19/12

(52) U.S. Cl. CPC B01J 19/127
USPC 204/157.3; 204/157.15; 422/186.03

(57) ABSTRACT

A photocatalytic process is disclosed for the reduction of carbon dioxide and water. The process comprises reacting carbon dioxide and water in the presence of a photocatalytic composition that is irradiated with electromagnetic radiation having a wavelength in the range of from 200 to 700 nm. The photocatalytic composition is capable of chemisorbing carbon dioxide.

### CROSS REFERENCE TO RELATED APPLICATIONS

This application is a continuation of PCT application number PCT/EP2012/060790 filed on 7 Jun. 2012, which claims priority from U.S. application No. 61/494,431 filed on 8 Jun. 2011. Both applications are hereby incorporated by reference in their entireties.

### BACKGROUND OF THE INVENTION

1. Field of the Invention

The invention relates generally to the conversion of carbon dioxide to liquid products and more particularly to the reaction of carbon dioxide with water.

2. Description of the Related Art

If solar energy could be used to convert carbon dioxide to liquid energy carriers and platform chemicals, it would be possible to capture solar energy in places where it is abundant, and to transport it in the form of liquid products to locations where the demand is greatest. Moreover, much of the existing petroleum infrastructure could be used in the transportation, storage and combustion of solar energy based liquid fuels. As all carbon present in these liquid fuels would be derived from carbon dioxide, the combustion of these fuels would be carbon neutral.

Chueh et al., “High-Flux Solar Driven Thermochemical Dissociation of CO2 and H2O Using Nonstoichiometric Ceria”, Science Vol. 330, pp 1797-1801 (2010), reports on a process for splitting carbon dioxide and water into carbon monoxide and hydrogen at elevated temperatures. The requisite high temperatures (on the order of 1600° C.) are obtained in a solar reactor. Ceria is partially dissociated into substoichiometric ceria and oxygen at these high temperatures. At a “low” temperature part of the cycle (<900° C.) substoichiometric ceria is reacted with carbon dioxide and water to form stoichiometric ceria, carbon monoxide and hydrogen. The high temperature cycle produces oxygen as a by-product. Due to the high temperatures involved, the process requires considerable capital investment. The dramatic temperature swings likely limits the useful life of the solar reactor.

Photocatalysts are materials that exhibit catalytic properties when irradiated with visible or u.v. light. The mechanism is speculated to be as follows. The materials involved have semiconductor properties in the sense that they have band structures characterized by a conduction band and valence bands, separated by a band gap that corresponds to the energy of visible light or u.v. light. When these materials are irradiated with light of energy exceeding the band gap, excitation of valence band electrons to the conduction band occurs. In this state oxidation-reduction reactions can occur, similar to electrolysis.

Examples of photocatalytic materials include the well known semiconductor materials, such as n-doped and p-doped silicon, gallium, arsenic, and the like; TiO₂; ZnO; CdS; GaP; SiC; K₄Nb₆O₁₇; K₂La₂Ti₃O₁₀; Na₂Ti₆O₁₃; BaTi₄O₉; and K₃Ta₃Si₂O₁₃. In bench experiments powders of these materials have been suspended in water and irradiated with light. Under these conditions the formation of hydrogen has been demonstrated.

U.S. Pat. No. 4,427,508 reports on a photocatalytic reaction of carbon dioxide in an aqueous slurry of semiconductor silicon (for example, single crystal p-silicon or n-silicon). Pure carbon dioxide was bubbled through the slurry. The use of silicon as the catalyst required a substantially oxygen-free reaction mixture. The reaction was carried out at 30° C. Methanol, formic acid and formaldehyde are reported as reaction products. Although invented more than 25 years ago, this process has not been implemented on a commercial scale, or at all.

Aurian-Blajeni et al., Photoreduction of Carbon Dioxide and Water into Formaldehyde and Methanol on Semiconductor Materials, Solar Energy Vol. 25, pp. 165-170) reports on experiments with a number of semiconductor powders. The reactants were water and carbon dioxide. Water was triply distilled and carbon dioxide was purified by bubbling through an aqueous solution of vanadous chloride to remove traces of oxygen.

Thus, there is a need for a process that uses affordable catalytic materials. There is a particular need for a process that can operate in the presence of oxygen. There is a further need for a process that is not limited to the use of a carbon dioxide rich reactant gas.

### BRIEF SUMMARY OF THE INVENTION

It is an object of the invention to provide a photocatalytic process for the reduction of carbon dioxide and water, said process comprises the steps of:
a. providing a photocatalytic composition capable of chemisorbing carbon dioxide;
b. reacting carbon dioxide and water in the presence of the photocatalytic composition while the photocatalytic composition is radiated with electromagnetic radiation having a wavelength in the range of from 200 nm to 700 nm.

Because of the capability of the catalytic composition of chemisorbing carbon dioxide, any type of reaction mixture comprising carbon dioxide can be used, including substantially pure carbon dioxide; carbon dioxide rich gas mixtures, such as flue gases; and carbon dioxide poor gas mixtures, such as ambient air.

Another aspect of the invention comprises the photocatalytic composition for use in the process of the invention.

### BRIEF DESCRIPTION OF THE DRAWINGS

The features and advantages of the invention will be appreciated upon reference to the following drawings, in which:

FIG. 1 is a schematic presentation of a system for carrying out the photocatalytic process of the invention.

### DETAILED DESCRIPTION OF THE INVENTION

The present invention provides a process for the reduction of carbon dioxide and water, by which liquid compounds are produced.

The process is a photocatalytic process for the reduction of carbon dioxide and water, said process comprises the steps of:
a. providing a photocatalytic material capable of chemisorbing carbon dioxide;
b. reacting carbon dioxide and water in the presence of the photocatalytic material while the photocatalytic material is radiated with electromagnetic radiation having a wavelength in the range of from 200 nm to 700 nm.

Examples of liquid products produced in the process include methanol, formaldehyde, and formic acid. Ethanol, higher alcohols, such as butanol, acetaldehyde and acetic acid may also be produced. If a catalytic composition is used having Fischer-Tropsch activity, the process can be used to produce hydrocarbons, such as olefins and alkanes.

The reaction can be carried out at moderate temperatures, for example in the range of from 50° C. to 400° C., more particularly in the range of from 100° C. to 250° C.

In one embodiment of the process water is present in its liquid form. This embodiment is particularly suitable when a relatively low reaction temperature is employed. For reaction temperatures below 100° C. the reaction vessel may be open to the atmosphere. For reaction temperatures above 100° C. an autoclave may be used. Solar energy can be used for heating the reaction vessel to the desired reaction temperature.

The catalytic composition can be suspended in water so as to form an aqueous slurry. A carbon dioxide containing gas can be bubbled through the slurry. Irradiation can be accomplished by exposing the reaction vessel to direct sunlight. It may be advantageous to concentrate sunlight, for example using minors and/or lenses.

In an alternate embodiment of the process water is present in gas form, for example dry steam. This embodiment of the process is particularly suitable for reaction temperatures in excess of 100° C.

The photocatalytic catalyst requires irradiation with electromagnetic radiation for it to exhibit its catalytic properties. In one embodiment sunlight is used as a source of electromagnetic radiation. Sunlight can be used as it is received at the location of the reaction vessel containing the photocatalytic material. It can be desirable to amplify sunlight by well known optical means, such as mirrors and/or lenses.

It can be advantageous to guide sunlight into the reaction vessel, for example by using optical fibers.

It can be advantageous to temporarily store sun energy, for example in the form of electrical energy. Stored electrical energy can be converted to electromagnetic radiation, so that the process of the invention can also be operated when no or insufficient sunlight is available, such as on cloudy days or during the nighttime hours. Light emitting diodes (LEDs) are a preferred means for converting electric energy to electromagnetic radiation, because of their high efficiency. But other light sources, such as incandescent light bulbs, mercury vapor lamps, and the like, may also be used.

The electromagnetic radiation generally has a wavelength in the range of from 200 nm to 700 nm, i.e., visible light and the part of the u.v. spectrum that is able to pass through the earth's atmosphere. The desired wavelength is in part governed by the composition of the photocatalytic material, as the electromagnetic radiation must provide sufficient energy for exciting valence electrons of the photocatalytic material into the conducting band. In other words, the band gap of the photocatalytic material determines a minimum frequency (and thus a maximum wavelength) of the electromagnetic radiation suitable for the photocatalytic process.

Electromagnetic radiation having a longer wavelength than the threshold value for exciting the photocatalytic material is also useful in the process, as it provides thermal energy required for maintaining the desired reaction temperature.

An important characteristic of the photocatalytic composition used in the process of the present invention is its capability to chemisorb carbon dioxide. Due to this property, the reaction mixture is enriched in carbon dioxide at and near the surface of the catalyst, so that meaningful conversions can be obtained with sources of carbon dioxide that have only a modest carbon dioxide content. This makes it possible to use air, which contains about 380 ppm carbon dioxide, as a carbon dioxide source for the process.

The photocatalytic composition preferably has a carbon dioxide chemisorption capacity of at least 1 wt % (0.15 mmole/g); more preferably the carbon dioxide chemisorption capacity is at least about 5 wt % (0.75 mmole/g). The carbon dioxide chemisorption capacity of the catalytic composition is measured at 25° C. and carbon dioxide pressure of 0.1 MPa.

Refractory oxides, such as titania, zirconia and ceria, are insulating materials. Nanoparticles of these materials, however, have semiconducting properties. Moreover, we have discovered, using infrared spectroscopy, that nanoparticulated ceria spontaneously adsorbs carbon dioxide to form surface carbonates. These two properties (chemical adsorption of carbon dioxide and semiconduction) make nanoparticulated ceria a suitable photocatalytic material for use in the process of the invention.

Other metal oxides, such as, stannia, ZnO, and the like, are known to have semiconductor properties when in nanoparticulate form. These metal oxides are suitable materials for incorporation in a photocatalytic material for use in the process of the invention. The carbon dioxide chemisorption capacity of the photocatalytic composition can be increased by incorporating a carbon dioxide adsorbent, such as calcium carbonate, potassium carbonate, hydrotalcite or a hydrotalcite-like material. Potassium carbonate and potassium oxide are a preferred adsorbents for CO₂, as these material releases adsorbed CO₂ at relatively low temperatures (in the range of from 120 to 180° C.). Titania is much less costly than e.g. zirconia and ceria. The combinations K₂CO₃/TiO₂ and K₂O/TiO₂ are preferred in many cases.

The term “hydrotalcite” as used herein refers to the layered double hydroxide of general formula (Mg₆Al₂(CO₃)(OH)₁₆-4(H₂O).

The term “hydrotalcite-like material” as used herein refers to layered double hydroxides having a crystal structure similar or identical to that of hydrotalcite, wherein at least part of the Mg ion is replaced with another divalent ion, and/or at least part of the Al ion is replaced with another trivalent ion.

The term “doped hydrotalcite material” as used herein refers to hydrotalcite and hydrotalcite-like materials containing a cation that is neither divalent nor trivalent. In most cases the dopant is a cation having a valence of +4 or +5.

Hydrotalcite, hydrotalcite-like materials and doped hydrotalcite materials are of particular interest for use in the photocatalytic composition for use in the process of the present invention.

Hydrotalcite per se is of interest because of its high capacity for carbon dioxide adsorption (about 1.2 to about 1.5 mmole/g). Hydrotalcite can be used as a support for nanoparticulated metal oxides, such as ceria.

Hydrotalcite can be modified to impart photocatalytic activity, for example by replacing at least part of Mg with Zn, and/or by introducing metal ions such as Ti and Cr. Photocatalytic hydrotalcite-like materials and doped hydrotalcite materials are particularly suitable as photocatalytic materials for use in the process of the present invention.

Step b. of the process generally produces a mixture of oxygenated hydrocarbons, in particular methanol, formaldehyde, and formic acid. It is believed that formaldehyde and formic acid are reaction intermediates in the formation of methanol. Accordingly, the methanol selectivity can be increased by increasing the activity of the catalyst, increasing the reaction temperature, and/or increasing the contact time with the catalyst.

Materials having Fischer-Tropsch (“F-T”) catalytic activity tend to produce longer-chain molecules, such as ethanol, acetic acid, and acetaldehyde. Materials having very high F-T activity may even produce hydrocarbons, such as alkanes and olefins.

### DESCRIPTION OF ILLUSTRATIVE EMBODIMENTS

The following is a description of certain embodiments of the invention, given by way of example only and with reference to the drawings.

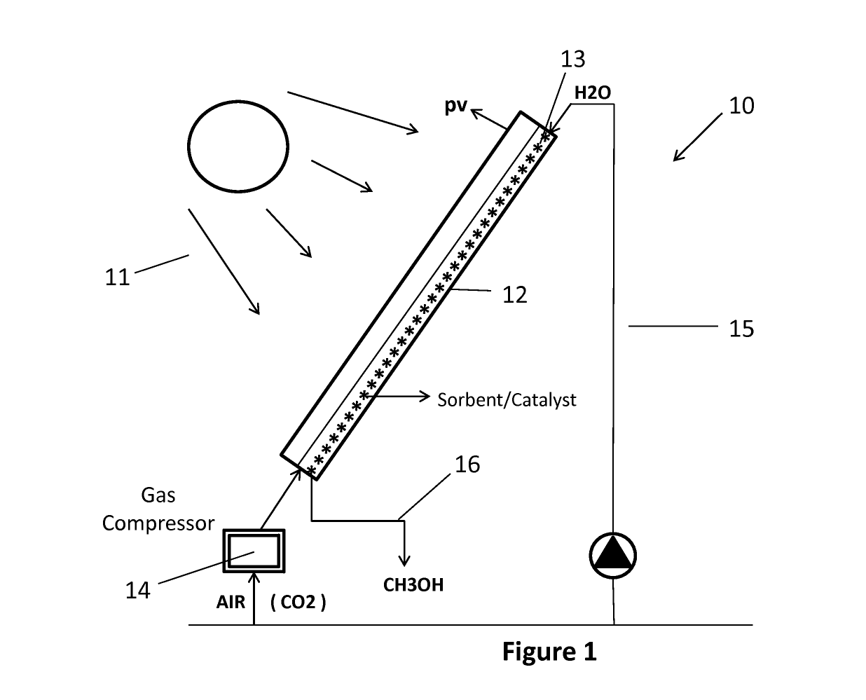

FIG. 1 is a schematic representation of a specific embodiment of the invention.

FIG. 1 shows a photocatalytic system 10, comprising a solar panel 12, which receives solar radiation 11. Solar panel 12 contains a layer of solid material 13. The solid material comprises an adsorbent material for carbon dioxide, such as potassium carbonate, calcium carbonate, or hydrotalcite. The solid material further comprises a photocatalytic material, such as titania. Solar panel 12 may be mounted on the rooftop of a building, such as an office building, an apartment building or a single-family home, in a manner similar to conventional photovoltaic solar panels.

The system comprises a gas compressor 14, which compresses a carbon-dioxide containing gas to a desired pressure, for example a pressure in the range of 20 to 50 bar. The carbon dioxide containing gas can be atmospheric air, or it can be a gas that is enriched in carbon dioxide. Examples of the latter include exhaust gases from fuel burning apparatus, such as coal, oil or gas fired heaters and boilers. In an alternate embodiment the fuel burning apparatus uses a renewable fuel, such as biomass.

Compressed carbon dioxide-containing gas is pumped into solar panel 12, and brought into contact with solid material 13. A water source, for example liquid water or steam, is pumped into solar panel 12 via conduit 15. Carbon dioxide and water, brought into contact with solid material 13, react to form a liquid fuel, such as methanol, under the influence of solar radiation 11.

Advantageously, carbon dioxide-containing gas can be pumped into solar panel 12 when no solar radiation is available, so as to allow the carbon dioxide adsorbent material to become saturated with carbon dioxide. When solar panel 12 is next exposed to solar radiation, the temperature of solid material 13 rises, causes desorption of adsorbed carbon dioxide. The temperature rise can be controlled by adjusting the temperature of steam 15 entering solar panel 12. Desorbing carbon dioxide produces a carbon dioxide-rich reaction mixture in the vicinity of the photocatalytic material present in solid material 13.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A photocatalytic process for the reduction of carbon dioxide and water, said process comprises the steps of:
(a) providing a photocatalytic composition capable of chemisorbing carbon dioxide;
(b) reacting carbon dioxide and water in the presence of the photocatalytic material while the photocatalytic composition is radiated with electromagnetic radiation having a wavelength in the range of from 200 nm to 700 nm.

2. The photocatalytic process of claim 1, wherein step (b) is carried out at a reaction temperature in the range of from 50° C. to 400° C.

3. The photocatalytic process of claim 1, wherein step (b) is carried out with water in its liquid form.

4. The photocatalytic process of claim 1, wherein step (b) is carried out with water in its vapor form.

5. The photocatalytic process of claim 1, wherein the electromagnetic radiation comprises sunlight.

6. The photocatalytic process of claim 1, wherein the photocatalytic composition has a carbon dioxide chemisorption capacity of at least 0.15 mmole/g and a relative carbon dioxide pressure of 0.1 MPa.

7. The photocatalytic process of claim 1, wherein the photocatalytic composition comprises nanoparticles of a refractory oxide.

8. The photocatalytic process of claim 7, wherein the photocatalytic composition comprises nanoparticles of titania or ceria.

9. The photocatalytic process of claim 8, wherein the photocatalytic composition comprises titania and potassium.

10. The photocatalytic process of claim 9, wherein the photocatalytic composition comprises K₂O and TiO₂.

11. The photocatalytic process of claim 1, wherein the photocatalytic composition comprises a hydrotalcite material.

12. The photocatalytic process of claim 11, wherein the hydrotalcite material comprises Zn, Ti, Cr, or a combination thereof.

13. The photocatalytic process of claim 1, wherein step (b) produces one or more hydrocarbon oxygenates.

14. The photocatalytic process of claim 13, wherein step (b) produces methanol.

15. A system for carrying out the photocatalytic process of claim 1, comprising a solar panel containing the photocatalytic composition and an adsorbent material for carbon dioxide.
